(19) United States
(12) Patent Application Publication
(10) Pub. No.: US 2012/0027956 A1
(43) Pub. Date: Feb. 2, 2012

(54) MODIFICATION OF NITRIDE TOP LAYER

(75) Inventors: Daewon Yang, Hopewell Junction, NY (US); Anthony Gene Domenicucci, Hopewell Junction, NY (US); Aurelia Suwarno-Handayana, Hopewell Junction, NY (US); Shamas Musthafa Ummer, Hopewell Junction, NY (US)

(73) Assignee: INTERNATIONAL BUSINESS MACHINES CORPORATION, Hopewell Junction, NY (US)

(21) Appl. No.: 12/846,050

(22) Filed: Jul. 29, 2010

(51) Int. Cl. H05H 1/24; C25F 3/00

(52) U.S. Cl. 427/579; 216/99

(57) ABSTRACT

A method of forming a nitride film is disclosed. In one embodiment, the method comprises performing an ending film deposition process that differs from the main film deposition process in terms of the flow rates of the reactive and ion source gases, and maintaining acceleration power of a CVD tool during the ending film deposition process. A post deposition process may also be used to remove a denser top layer of nitride, resulting in a nitride film having a consistent density.

### FIELD OF THE INVENTION

The present invention relates generally to semiconductor fabrication, and more particularly to nitride films.

### BACKGROUND OF THE INVENTION

Consumer electronics devices are driving trends in miniaturization. As consumers are demanding products with more processing power, and smaller physical size, there is a need to improve the performance of various integrated circuits. This need has pushed semiconductor technology and chip manufacturing towards advances that have resulted in a steady increase of the number of transistors on a single chip. This has continued to drive the feature size of semiconductors smaller and smaller.

One of the most frequently required processes in the fabrication of IC circuits is the nitride deposition process. Nitride films play an important role in semiconductor fabrication, and as semiconductor fabrication technology continues to advance, and feature size continues to reduce, there is a need for improved nitride films and methods for forming and modifying the nitride films.

### SUMMARY

In one embodiment of the present invention, a method of forming a nitride film is provided. The method includes performing a main film deposition using a high density plasma chemical vapor deposition tool. The main film deposition process comprises administering a first reactive source gas at a first main flow rate, a second reactive source gas at a second main flow rate, and an ion source gas at a third main flow rate.

The method further includes performing an ending film deposition process using the high density plasma chemical vapor deposition tool. The ending film deposition process comprises reducing the flow rate of the first reactive source gas from the first main flow rate to a first ending flow rate gradually over a ramp time interval, and maintaining acceleration power of the high density plasma chemical vapor deposition tool.

In another embodiment of the present invention, an alternate method of forming a nitride film is provided. This method includes performing a main film deposition process using a chemical vapor deposition tool and performing a post deposition conditioning process to remove a top layer of the nitride film.

In yet another embodiment of the present invention, an additional method of forming a nitride film is provided. This method includes the steps of performing a main film deposition process using a high density plasma chemical vapor deposition tool. The main film deposition process comprises administering SiH4 gas at a first main flow rate, N2 gas at a second main flow rate, and argon gas at a third main flow rate. An ending film deposition process is performed using the high density plasma chemical vapor deposition tool. The ending film deposition process comprises reducing the flow rate of the SiH4 gas from the first main flow rate to zero gradually over a ramp time interval, and maintaining acceleration power of the high density plasma chemical vapor deposition tool.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGs) of the drawing, in which case typically the last two significant digits may be the same, the most significant digit being the number of the drawing figure (FIG).

FIG. 1 shows a prior art main film deposition process.

FIG. 2 shows a prior art ending film deposition process.

FIG. 3 is a depth-density graph of a film formed by the prior art process.

FIG. 4 shows an ending film deposition process in accordance with an embodiment of the present invention.

FIG. 5 is a depth-density graph of a film formed by embodiments of the present invention.

FIG. 6 is a flowchart indicating process steps for embodiments of the present invention.

FIG. 7A shows a nitride film prior to undergoing post deposition conditioning.

FIG. 7B shows a nitride film after undergoing post deposition conditioning.

### DETAILED DESCRIPTION

Throughout the descriptions set forth in this disclosure, lowercase numbers or letters may be used, instead of subscripts. Regarding the use of subscripts (in the drawings, as well as throughout the text of this document), sometimes a character (letter or numeral) is written as a subscript—smaller, and lower than the character (typically a letter) preceding it, such as “Vₛ” (source voltage) or “H₂O” (water). For consistency of font size, such acronyms may be written in regular font, without subscripting, using uppercase and lowercase—for example “Vs” and “H2O”.

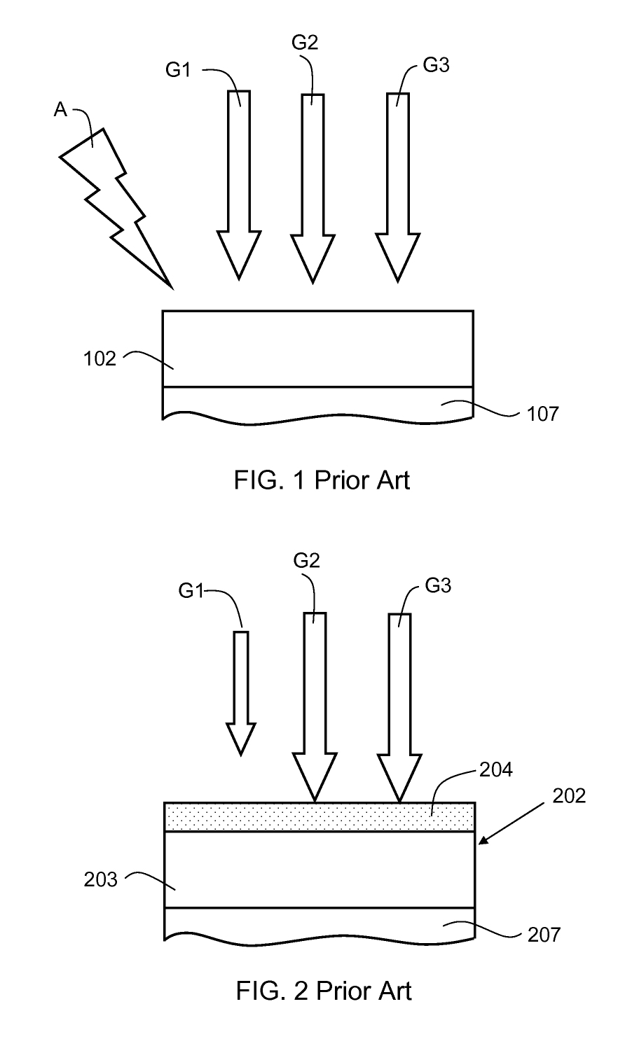

For the purpose of providing context for describing embodiments of the present invention, the prior art will be briefly discussed. FIG. 1 shows a prior art main deposition phase of a prior art high density plasma (HDP) chemical vapor deposition (CVD) process. Film 102 is a silicon nitride film (Si3N4) which is deposited on substrate 107, which may be silicon, or another semiconductor substrate. A HDP-CVD tool (not shown), which is widely used in the industry, is used to perform the HDP-CVD process. A plurality of gases G1, G2 (reactive source gases), and G3 (ion source gas, which is an inert carrier gas) are fed into a reaction chamber of the HDP-CVD tool. Typically, gas G1 is SiH4, gas G2 is N2, and gas G3 is an inert gas, such as Ar+ (ionized Argon). As the gases are fed into the reaction chamber, an inductive discharge is created by applying an alternating-current (AC) or radio-frequency (RF) signal between an electrode and the conductive walls of the reactor chamber, or between two cylindrical conductive electrodes facing one another. The latter configuration is known as a parallel plate reactor. Frequencies of tens of kilohertz to tens of megahertz result in reasonable discharges.

Excitation frequencies in the low-frequency (LF) range, usually on the order of hundreds of kHz, require several hundred volts to sustain the discharge. These large voltages lead to high-energy ion bombardment of surfaces. High-frequency plasmas are often excited at the standard 13.56 MHz frequency widely available for industrial use; at high frequencies, the displacement current from sheath movement and scattering from the sheath assist in ionization, and thus lower voltages are sufficient to achieve higher plasma densities. The low frequency excitation is sometimes referred to as the source power of the HDP-CVD tool, and serves to generate plasma. The high frequency excitation is sometimes referred to as the acceleration power or bias power, and is indicated symbolically as A in FIG. 1. The acceleration power A serves to control the direction and speed of the plasma, and in effect, accelerates the ion species towards the silicon wafer (substrate) on which the nitride film is being formed.

FIG. 2 shows an ending deposition phase of a prior art HDP-CVD process. As the deposition ends, the acceleration power is removed (compare with A of FIG. 1, which is not present in FIG. 2). Furthermore, the flow of Nitrogen (G2) and Argon gas (G3) continues as in the main film deposition process shown in FIG. 1, and the flow of silane (SiH4), indicated as G1 continues, but at a reduced flow rate as compared to the main deposition phase (the smaller arrow for G1 in FIG. 2 as compared with the arrow for G1 in FIG. 1 denotes a lower flow rate for G1 in FIG. 2 as compared with that of FIG. 1). This has the effect of changing the film density of the top layer 204 of nitride film 202. The top layer 204 has a considerably higher density than the bulk layer 203. For example, the film density of the bulk layer 203 may be in the range of about 2.7 to 2.85 gm/cm, whereas the film density of top layer 204 may be in the range of about 2.9 to 3.0 gm/cm. Bulk layer 203 may be on the order of 300-800 angstroms thick, whereas top layer 204 may be on the order of 30-70 angstroms thick. In addition to being thicker than bulk layer 203, top layer 204 is also “uncontrolled.” This means that top layer 204, which is the last part of film 202 to be formed, has a density that may vary considerably from sample to sample.

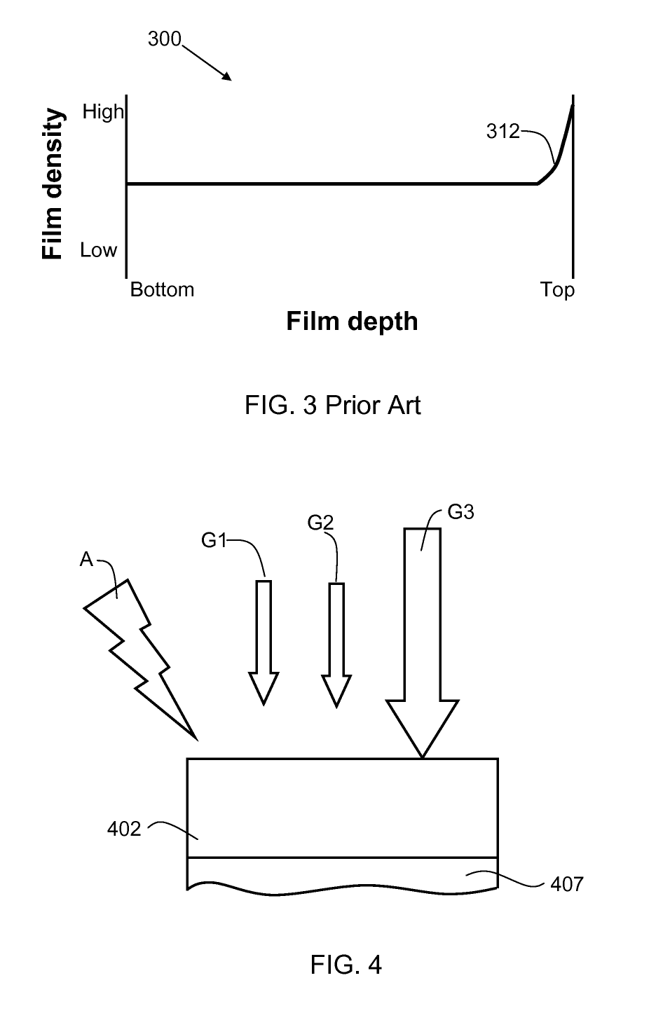

FIG. 3 shows a depth-density graph 300 of a film formed by the prior art process. The horizontal axis represents film depth, with the bottom of the film on the left side of the graph, and the top of the film on the right side of the graph. The vertical axis represents film density. Density plot 312 curves upwardly near the top of the film, indicating an increase in film density at the top.

The increased film density, plus the uncontrolled nature of the ending deposition phase can result in increased manufacturing defects which can adversely affect product yield. The increased density of top layer 204 (FIG. 2) causes gases to get trapped within the nitride film. If the gases are trapped, they can cause damage to the top layer of the nitride during subsequent fabrication steps. The damage can lead to delamination, and may result in contacts becoming shorted together, resulting in a device failure. Therefore, it is desirable to prevent or remove the uncontrolled top nitride layer, and achieve a nitride layer with a uniform density, or possibly a top layer that has a decreased density as compared with the bulk layer.

FIG. 4 shows an ending deposition phase of a HDP-CVD process in accordance with an embodiment of the present invention. In this ending deposition phase, gas G3 (inert gas), which may be Ar+, continues flowing into the reaction chamber of the HDP-CVD tool as the flow of gases G1 and G2, representing SiH4 and N2, respectively, are gradually decreased over the ramp time interval. This allows the density of nitride layer 402 to be uniform, with no considerable density difference between the top 30-80 angstroms and the remainder of the nitride layer 404. This takes advantage of deposition characteristics of high density plasma CVD for nitride film deposition, which cause film density to decrease as plasma bombardment (sputtering) increases. Prior art CVD (including plasma CVD) depositions produce an undesired very thin top layer which has a different density than the bulk layer. In the ending deposition phase shown in FIG. 4, the acceleration power A continues to be applied, which differs from the prior art ending deposition phase shown in FIG. 2. The ending deposition phase shown in FIG. 4 serves to prevent issues such as adhesion, or de-lamination. In one embodiment of the present invention, using a HDP (High Density Plasma) CVD nitride film, plasma bombardment is maintained while reactive gases (SiH4 and N2) are completely purged out from the process chamber, which prevents the denser top layer formation (compare with 204 of FIG. 2. In one embodiment, Argon is used as the inert gas in the HDP-CVD process. In another embodiment, Helium is used as the inert gas in the HDP-CVD process.

The acceleration power of the HDP-CVD tool is maintained during the ending deposition phase. In one embodiment, the acceleration power is in the range of about 1000 W (watts) to about 1500 W, and has a frequency of 13.56 MHz. The source power, used to generate the plasma, is in the range of 3000 W-4000 W, with a frequency in the range of about 200 KHz to about 600 KHz.

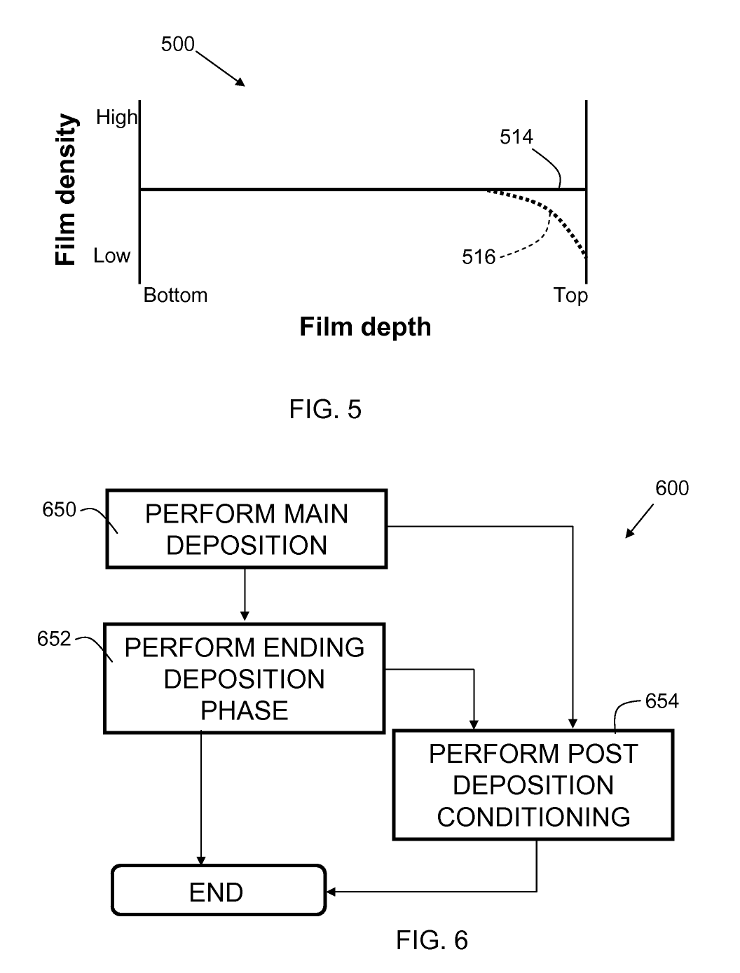

FIG. 5 is a depth-density graph 500 of a film formed by an embodiment of the present invention. The horizontal axis represents film depth, with the bottom of the film on the left side of the graph, and the top of the film on the right side of the graph. The vertical axis represents film density. Density plot 514 remains flat near the top of the film (compare with 312 of FIG. 3, which curves upwardly near the top of the film), indicating a similar film density throughout the film. Alternatively, the top layer of the film can be made less dense, which would result in the curve indicated as 516. In order to achieve film density having the curve indicated as 516, a higher acceleration power is used during the ending film deposition process. Since the film density varies inversely with acceleration power, the film density is reduced in the top layer. Such a layer as depicted by curve 516, having a decreased density at the top, serves to minimize the amount of gas trapped in the film. Gas trapped in the film can cause film de-lamination and other defects, and hence, it is desirable to minimize the amount of gas trapped in the film.

FIG. 6 is a flowchart 600 indicating process steps for embodiments of the present invention. In process step 650, a main film deposition process is performed via a HDP-CVD tool. In process step 652, an ending deposition phase is performed.

In one embodiment, the flow rates of the gases used during the main deposition phase are as follows: The SiH4 flow rate ranges from about 50 to about 150 sccm (standard cubic centimeters per minute), with a preferred value of about 90 sccm. The N2 flow rate ranges from about 200 to about 500 sccm (standard cubic centimeters per minute), with a preferred value of about 310 sccm. The argon flow rate ranges from about 150 sccm to about 400 sccm with a preferred value of about 230 sccm. In another embodiment, helium is used as the inert gas in place of argon.

In one embodiment, the flow rates of the gases used during the ending deposition phase are gradually changed from the following values over a predetermined time interval, referred to as the ramp time interval. In one embodiment, the starting and ending limits for the flow rates of the gases are as follows: The SiH4 flow rate starts at about 90 sccm and ends at 0 sccm. The N2 flow rate starts at about 310 sccm and ends at about 0 sccm. The decrease in N2 flow rate during the ending deposition phase is optional. The argon flow rate starts at about 230 sccm and increases to about 600 sccm. The increase in argon serves to maintain stability of plasma during the ending deposition phase. In one embodiment, the ramp time interval is 3 seconds.

In process step 654, post deposition conditioning is performed. The post deposition conditioning process may comprise removal of a top layer of nitride by wet etch or RIE (reactive ion etch). In the case of a wet etch, the etchant used may comprise dilute HF (hydrofluoric acid) or hot phosphoric acid.

The arrows of flowchart 600 indicate various possible process sequences. One such sequence is to perform main deposition 650, followed by the ending deposition phase 652, as described previously, which prevents a dense top layer of nitride. Alternatively, a main film deposition process 650 is performed, followed by a post deposition conditioning step 654 to remove the dense top layer of nitride. Another embodiment comprises a combination sequence of main deposition 650 followed by ending deposition phase step 652 followed by a post deposition conditioning step 654.

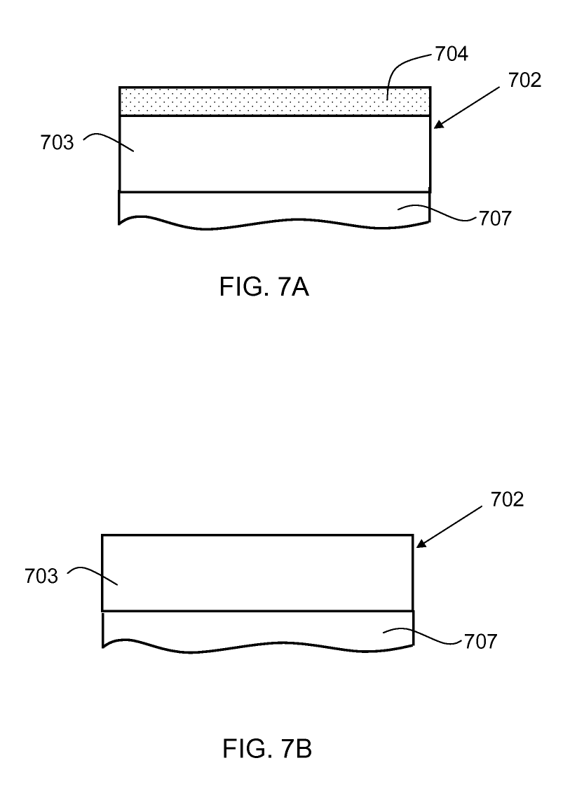

FIG. 7A shows a nitride film 702 prior to post deposition conditioning for the embodiment after a main film deposition process 650 is performed. The top layer 704 has a higher density than the bulk layer 703.

FIG. 7B shows nitride film 702 after the post deposition conditioning process 654. The denser top layer (704 of FIG. 7A) is now removed, and nitride layer 702 is comprised of bulk layer 703 which has the denser top layer removed (compare with 704 of FIG. 7A).

As can now be appreciated, embodiments of the present invention provide the ability to fabricate nitride films having a constant density profile, meaning that the density of the top layer is essentially the same as the density of the bulk layer. In other embodiments, the parameters of the ending deposition phase are adjusted such that top layer is less dense than the bulk layer.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method of forming a nitride film, comprising the steps of:
providing a substrate;
performing a main film deposition process to said substrate using a high density plasma chemical vapor deposition tool, the main film deposition process comprising administering a first reactive source gas at a first main flow rate, a second reactive source gas at a second main flow rate, and an ion source gas at a third main flow rate while applying an acceleration power of the high density plasma chemical vapor deposition tool thereby depositing said nitride film onto said substrate;
performing an ending film deposition process to said substrate using the high density plasma chemical vapor deposition tool, the ending film deposition process comprising reducing the flow rate of the first reactive source gas from the first main flow rate to a first ending flow rate gradually over a ramp time interval while maintaining said acceleration power of the high density plasma chemical vapor deposition tool.

2. The method of claim 1, wherein the ion source gas is comprised of argon.

3. The method of claim 1, wherein the ion source gas is comprised of helium.

4. The method of claim 1, wherein the first source gas comprises SiH4 and the second source gas comprises N2.

5. The method of claim 1, wherein maintaining the acceleration power comprises maintaining the acceleration power within a range from about 1000 watts to about 1500 watts.

6. The method of claim 5, wherein the acceleration power is applied at a frequency of 13.56 MHz.

7. The method of claim 1, wherein the third main flow rate ranges from about 150 sccm to about 400 sccm.

8. The method of claim 4, wherein the first main flow rate ranges from about 50 sccm to about 150 sccm, and the second main flow rate ranges from about 200 sccm to about 500 sccm.

9. The method of claim 1, wherein the ending film deposition process further comprises the step of reducing the flow rate of the second reactive source gas from the second main flow rate to a second ending flow rate gradually over the ramp time interval.

10. The method of claim 1, wherein the ending film deposition process further comprises the step of increasing the ion source gas flow rate from the third main flow rate to a third ending flow rate gradually over the ramp time interval.

11. The method of claim 1, further comprising the step of performing a post deposition conditioning process to remove a top layer of the nitride.

12. The method of claim 11, wherein the post deposition conditioning process comprises a wet etch.

13. The method of claim 12, wherein the wet etch is performed with an etchant comprising HF.

14. The method of claim 11, wherein the post deposition conditioning process comprises a reactive ion etch.

15. A method of forming a nitride film, comprising the steps of:
performing a main film deposition process using a chemical vapor deposition tool to create said nitride film on a substrate;
performing a post deposition conditioning process to remove a top layer of the nitride film, wherein the top layer thickness ranges from about 30 angstroms to about 70 angstroms.

16. The method of claim 15, wherein the post deposition conditioning process comprises a wet etch.

17. The method of claim 15, wherein the post deposition conditioning process comprises a reactive ion etch.

18. A method of forming a nitride film, comprising the steps of:
providing a substrate;
performing a main film deposition process using a high density plasma chemical vapor deposition tool, the main film deposition process comprising administering SiH4 gas at a first main flow rate, N2 gas at a second main flow rate, and argon gas at a third main flow rate while applying an acceleration power of the high density plasma chemical vapor deposition tool thereby forming said nitride film on said substrate;
performing an ending film deposition process using the high density plasma chemical vapor deposition tool, the ending film deposition process comprising reducing the flow rate of the SiH4 gas from the first main flow rate to zero gradually over a ramp time interval while maintaining said acceleration power of the high density plasma chemical vapor deposition tool.

19. The method of claim 18, wherein the ending film deposition process further comprises the step of increasing the argon gas flow rate from the third main flow rate to a third ending flow rate gradually over the ramp time interval.

20. The method of claim 19, wherein the ending film deposition process further comprises the step of decreasing the N2 gas flow rate from the second main flow rate to zero gradually over the ramp time interval.
